(19) United States
(12) Patent Application Publication
(10) Pub. No.: US 2011/0010208 A1
(43) Pub. Date: Jan. 13, 2011

(54) METHOD FOR INTEGRATED CLIMATE CHANGE MITIGATION & ADAPTATION

(76) Inventor: Barak Yekutiely, Kochav Yair (IL)

Correspondence Address: David Klein;DEKEL PATENT LTD., Beit HaRof'im, 18 Menuha VeNahala Street, Room 27, Rehovot, IL

(21) Appl. No.: 12/499,811

(22) Filed: Jul. 9, 2009

(51) Int. Cl. G06Q 10/00; G06Q 50/00

(52) U.S. Cl. 705/7

(57) ABSTRACT

A method for integrated climate change mitigation and adaptation including analyzing available energy sources and grading said energy sources in terms of both climate change mitigation factors and climate change adaptation factors, and choosing and implementing energy sources that score highest in terms of both mitigation and adaptation.

### FIELD OF THE INVENTION

The present invention relates generally to methods for implementing energy programs and policies by taking into consideration both climate change mitigation effects and climate change adaptation effects.

### BACKGROUND OF THE INVENTION

The Clean Development Mechanism (“CDM”) is part of the Kyoto protocol, and is discussed in http://unfccc.int/kyoto_protocol/mechanisms/clean_development_mechanism/items/2718.php.

The CDM is a market mechanism that allows a country with an emission-reduction or emission-limitation commitment under the Kyoto Protocol to implement an emission-reduction project in developing countries to offset the carbon costs of development in its home country

### SUMMARY OF THE INVENTION

The present invention seeks to provide a method for implementing energy programs and policies by taking into consideration both climate change mitigation effects and climate change adaptation effects, as is described more in detail hereinbelow. The method includes a Comprehensive Sustainability Mechanism or Method (“CSM”).

The CSM is an improved version of CDM that is government controlled. CSM allows a country to analyze, rate, and regulate various forms of “clean” or “green” solutions on the basis of their comprehensive tangible benefits in the area of climate change mitigation and adaptation (emissions, water, land, agriculture, and other externalities, etc). For example, in the prior art (like CDM), a country may choose to power a large percentage of their manufacturing facilities with coal, gas or other fossil-based fuels and offset the unacceptable emissions with funding for wind or solar energy projects in third world countries. In the prior art, this may meet the short-sighted goals of international policy makers and make the country look good in the eyes of the world, but still may wreck havoc on the environmental future of the country. In the CSM, the climate change mitigation benefits (e.g., reduced emissions) are also taken into consideration (not just economic incentives of something like CDM), and also the climate change adaptation benefits/detriments, such as but not limited to, revitalized ecosystems and reservoir enhancement in the case of benefits or in the case of detriments such as but not limited to natural resource consumption including water use, land use, deforestation, desertification, reduced agriculture, harm to ecosystems and/or to biodiversity.

There is thus provided in accordance with an embodiment of the present invention a method for integrated climate change mitigation and adaptation including analyzing available energy sources and grading the energy sources in terms of both climate change mitigation factors and climate change adaptation factors, and choosing and implementing energy sources that score highest in terms of both mitigation and adaptation.

The grading includes giving more grading points to energy sources that have reduced emissions. The grading includes giving more grading points to energy sources that cause revitalization of ecosystems. The grading includes giving more grading points to energy sources that enhance reservoir quality. The grading includes giving more grading points to energy sources that require less agricultural investment. Other examples will be apparent from the description.

### BRIEF DESCRIPTION OF THE DRAWINGS

The present invention will be understood and appreciated more fully from the following detailed description taken in conjunction with the drawings in which:

FIG. 1 is a simplified flow chart of a method for integrated climate change mitigation and adaptation, in accordance with an embodiment of the invention.

### DETAILED DESCRIPTION OF EMBODIMENTS

The present invention provides a method for implementing energy programs and policies by taking into consideration both climate change mitigation effects and climate change adaptation effects. This is in contrast with the prior art which considers only one effect, either climate change mitigation or climate change adaptation, but not both. By uniquely taking into consideration both climate change mitigation effects and climate change adaptation effects, the present invention enables countries, policy makers, companies, etc. to intelligently choose and manage energy resources and investments and optimize tradeoffs between different types of energy resources and investments.

Climate change mitigation benefits include, but are not limited to, reduced emissions and renewed economics. Reduced emissions refers to, for example, reduced use of fossil-based fuels, and increased use of water power, solar energy, wind energy, and the like. Renewed economics refers to significant economic benefits that can be achieved and measured using the Comprehensive Sustainability Mechanism or Method (“CSM”), and example of which is described hereinbelow. CSM is a means for countries to accelerate large scale adoption of renewable energy sources (unlike the existing quota caps and focus on costs for reaching grid parity) for mitigating and adapting to climate change, reducing dependence on fossil fuels, while resolving the tradeoffs resulting from large scale implementation in both economic and environmental costs to society.

The CSM is not to be confused with the Clean Development Mechanism (“CDM”). The CSM, unlike CDM which focuses just on the carbon aspects of climate change mitigation, provides a practical means for countries to offset otherwise unacceptable costs of developing large scale renewable energy sources by looking beyond the energy sector (what is sometimes referred to as the water-energy nexus or water-energy-land nexus, etc.). The CSM can become the basis for new policies and regulations for renewable energy and environmental solutions that provide incentives and quotas for solutions/technologies (such as AQUATE-RE/WIPV described below) that integrate climate change mitigation and adaptation and thus allow the countries to meet their CO₂ reduction targets while doing so in both an economically and environmentally sustainable manner. Similar to CDM, CSM professional service providers provide solution and technology companies consulting services for having their solutions become CSM rated and approved.

CSB—The Comprehensive Sustainability Bond (“CSB”) is a flexible financial instrument that supports efficient capital raising for implementation of CSM-based solutions (like the AQUATE-RE/WIPV system described below).

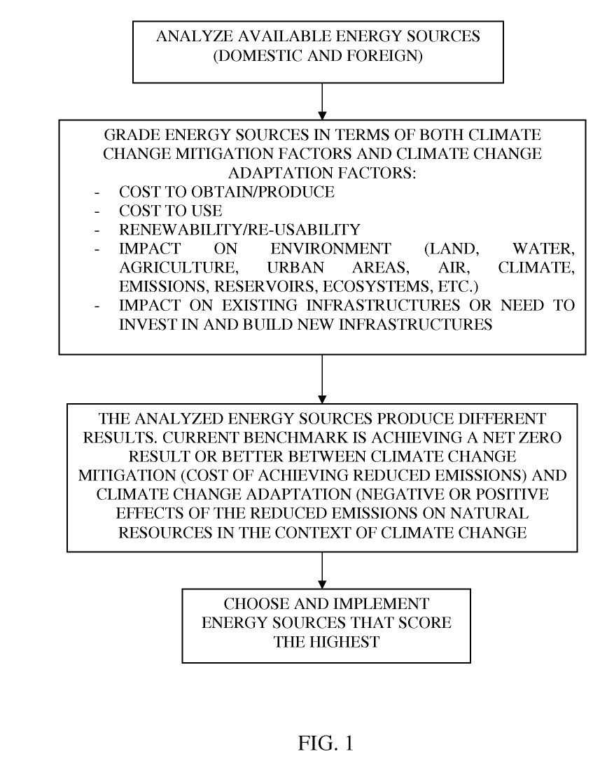

Reference is now made to FIG. 1, which illustrates a flow chart of a method for integrated climate change mitigation and adaptation, in accordance with one embodiment of the invention.

Available energy sources (domestic and foreign) are analyzed. These energy sources are graded (given points on a weighted scale) in terms of both climate change mitigation factors and climate change adaptation factors. These factors include, but are not limited to, cost to obtain/produce, cost to use, predictability to implementation, renewability/re-usability, impact on environment (land, water, agriculture, urban areas, air, climate, emissions, reservoirs, ecosystems, etc.), and impact on existing infrastructures or need to invest in and build new infrastructures.

All energy sources that are analyzed in the CSM will produce different results and the current benchmark is achieving a net zero result or better between climate change mitigation (cost of achieving reduced emissions) and climate change adaptation (negative or positive effects of the reduced emissions on natural resources in the context of climate change). Only solutions that address both mitigation and adaptation can score highly in the CSM.

The final step of the method is choosing and implementing the energy sources that score the highest through efficient government policies and regulations that incentivize solutions that address both climate change mitigation and adaptation. The incentives can be provided for example through increased quota caps and pricing differentials for various solutions relative to the benchmark.

The following is just one example of choosing an energy plan with the method of the invention, referred to as the AQUATE-RE/WIPV (water integrated photovoltaic system).

In this system, large scale solar-water interfaces are installed directly on the surface of exiting water reservoirs, to provide climate change mitigation benefits (e.g., reduced emissions and renewed economics) and climate change adaptation benefits (e.g., revitalized ecosystems and reservoir enhancement).

The CSM of the invention improves the current economics of photovoltaics from being the most expensive of the renewable energy sources to one that is cheaper than fossil fuel driven energy. The invention achieves this by providing significant savings in contributing water saved for agriculture uses and alternative land use for expanding agriculture, such as for food for human consumption, feed for animal consumption and bio-fuels and the like. WIPV floating solar panel technology prevents water loss through evaporation it therefore has the twofold economic benefit of reducing the cost of water desalinated and increasing the water available for agricultural purposes.

Presently, food crises have arisen due to the other fuel sources (e.g., ethanol and biodiesel) made from crops that utilize farm land and consume water, and which have the added disadvantage of not being economically sustainable. In contrast to these problems, the WIPV floating solar panel technology is the opposite—it generates clean energy and contributes water and land for agriculture. There are other factors that play a role in the model that further increase its appeal and making it truly comprehensive (carbon credits, carbon reduction, avoided peak power, etc.), as is now explained below.

The tables below set out the key financial and economic cash flows for sample projects within the Aquate Solar Ltd. portfolio of WIPV facilities proposed under the Comprehensive Sustainability Programs (“CSP”) for countries such as Israel, Spain, France, Portugal, and Turkey. The key assumptions used in deriving these figures have been summarized below the economic outputs.

We have demonstrated the results at both societal and project based discount rates. Under both scenarios the cost of the subsidy received through the power tariff is substantially less than the benefits society should accrue where water is a scarce resource.

Example Project—Financial Model Outputs

| Capacity | 50 MWp |
|---|---|
| Capital Costs | $216,319k |
| Project length | 20 years |
| Tariff | $550/MWh |
| Project NPV (post tax) | $57,726k |
| Discount rate | 10% |
| Pre-tax IRR | 11.3% |

Example Project—Economic Model Outputs

| | NPV | NPV |
|---|---|---|
| Description | @3.5% ($′000) | @10% ($′000) |
| Cost of power - tariff | (438892) | (257082) |
| Carbon Credits | — | — |
| Voluntary Water Certificates | — | — |
| Avoided costs of desalination | 19965 | 9971 |
| of water | | |
| Economic multiplier effect | 776695 | 387915 |
| Local employment | 160338 | 80080 |
| Alternative land use | 20885 | 10951 |
| Carbon reduction | — | — |
| Avoided peak power load | — | — |

Key Assumptions

NPV (net present value) has been calculated using the project discount factor of 10% and an alternative rate of 3.5%, the discount factor of 3.5% is more appropriate when considering societal benefits.

Water is assumed to be a major limiting factor in many countries. As the WIPV floating solar panel technology prevents water loss through evaporation it therefore has the twofold economic benefit of reducing the cost of water desalinated and increasing the water available for agricultural purposes. We have assumed that the full reservoir water volume is saved at a conservative evaporation rate of 1.5 m a year and have applied a desalination cost of $0.53 per cubic meter; this figure has been stated as the costs of desalination for the Ashkelon desalination plant in Israel. The total cost of desalinated water was used as a basis of the calculation of the impact of the multiplier effect of agriculture. Water as a percentage of agricultural inputs in Israel was applied to this cost; a total agricultural output was then derived using the ratio of agricultural outputs to inputs in Israel. An agricultural multiplier of 2.18 was applied to the total agricultural outputs to give the economic impact of the increase in agricultural activity.

The projects will create employment in a manufacturing facility for the solar equipment. We have assumed that 200 employees will be employed by the manufacturing facility for and that they will continue to be employed by the facility for the duration of the project. Each employee is assumed to receive the average salary in Israel per the Central Bureau of Statistics. An economic multiplier for manufacturing was applied to the total salary cost to determine the economic impact of increased manufacturing employment.

A value for alternative land use has been calculated assuming that using the reservoir for the solar plant has saved land which could be used for agriculture. An average agricultural value of the land has been derived using the total agricultural output for Israel and the total area under cultivation.

The model includes functionality to calculate the economic benefit of carbon credits, voluntary water certificates, carbon reduction and avoided peak power load.

In summary, the above example of WIPV is just one example of integrated climate change mitigation and adaptation, in accordance with an embodiment of the invention.

Contrary to the example of WIPV graded with the CSM, BIPV sometimes referred to as building integrated photovoltaics could present similar mitigation benefits as in the case of WIPV. However, BIPV does not generate any additional economic benefits relating to climate change adaptation nor does it provide any detriment to climate change adaptation. BIPV is therefore climate change adaptation neutral and on the grading system would provide a lesser score than WIPV as its neutral adaption disposition cannot offset any costs for achieving its mitigation benefits.

Assuming we use the same PV technology in WIPV and BIPV and now apply it to a land based PV installation (“LBPV”) or sometimes referred to as a solar farm, the mitigation benefits again would be comparable however in the LBPV case there are detriments related to climate change adaptation such as excessive land use, water use to clean the PV, and loss of agriculture assuming the solar farm is on agriculture designated land.

The scope of the present invention includes both combinations and subcombinations of the features described hereinabove as well as modifications and variations thereof which would occur to a person of skill in the art upon reading the foregoing description and which are not in the prior art.

What is claimed is:

1. A method for integrated climate change mitigation and adaptation comprising:
analyzing available energy sources and grading said energy sources in terms of both climate change mitigation factors and climate change adaptation factors; and
choosing and implementing energy sources that score highest in terms of both mitigation and adaptation.

2. The method according to claim 1, wherein said grading comprises giving more grading points to energy sources that have reduced emissions.

3. The method according to claim 1, wherein said grading comprises giving more grading points to energy sources that cause revitalization of ecosystems.

4. The method according to claim 1, wherein said grading comprises giving more grading points to energy sources that enhance reservoir quality.

5. The method according to claim 1, wherein said grading comprises giving more grading points to energy sources that require less agricultural investment.
